(19) United States
(12) Patent Application Publication
(10) Pub. No.: US 2013/0134940 A1
(43) Pub. Date: May 30, 2013

(54) POWER CONTROL APPARATUS

(71) Applicant: Ryuichiro Tominaga, Osaka (JP)

(72) Inventor: Ryuichiro Tominaga, Osaka (JP)

(73) Assignee: SANYO ELECTRIC CO., LTD., Osaka (JP)

(21) Appl. No.: 13/816,114

(22) PCT Filed: Aug. 9, 2011
(86) PCT No.: PCT/JP2011/068144

§ 371 Date: Feb. 8, 2013

(30) Foreign Application Priority Data
Aug. 9, 2010 (JP) 2010-178493

(51) Int. Cl. H02J 7/00

(52) U.S. Cl. CPC H02J 7/007
USPC 320/109

(57) ABSTRACT

The power supplying system is provided with: a timing determining unit for determining the timing at which charging and/or discharging of a storage battery, which stores power by being charged and supplies power by being discharged, is to be executed; and a controllable period estimation unit for estimating a controllable period, which is a period of time wherein the timing determining unit is able to determine the timing at which to execute the charging or discharging of the storage battery. The timing determining unit determines the timing at which to execute the charging and/or discharging of the storage battery on the basis of the controllable period.

### TECHNICAL FIELD

The present invention relates to a power supply system that supplies electric power through control of charging and discharging of a storage battery.

### BACKGROUND ART

In recent years, there has been proposed a power supply system that provides electric power to be consumed in a household, a store, a building or the like by using not only system power (electric power supplied from a power company; the same applies in the following) but also electric power supplied by discharging a storage battery. A storage battery is charged in advance by consuming system power and thus can supply electric power by being discharged at an arbitrary timing. This means that, by controlling timings for charging and discharging a storage battery, a timing for consuming system power can be controlled.

Typically, the electric power cost of system power includes a fixed base rate and a metered usage-based rate. Power companies set the base rate so that the base rate becomes lower with decreasing maximum value of the amount of system power consumed per unit time period. They also set the usage-based rate so that the usage-based rate per unit electric power is lower during the nighttime when power consumption can be decreased than during the daytime when power consumption can be increased. Thus, the more power consumption is leveled, the more the electric power cost can be reduced. Furthermore, leveling of power consumption is preferable in that it allows a power company to perform efficient power generation (particularly, thermal power generation) and thus can reduce the amount of carbon dioxide emitted as a result of the power generation.

In the above-described power supply system, power consumption can be leveled, for example, by discharging the storage battery when the amount of electric power consumed per unit time period is increased instantaneously or by charging the storage battery in the nighttime and discharging it in the daytime. In a case, however, where such a power supply system is introduced in a store or the like, a large-scale storage battery is needed. Consequently, the store or the like is required to incur the cost of installing and maintaining the storage battery and to secure a site for installing the storage battery. Being required as described above to incur the cost and to secure the site might hinder the store or the like from introducing the power supply system therein.

Each of Patent Document 1 and Patent Document 2 proposes a power supply system that uses a storage battery provided in an electric-powered vehicle. The power supply system controls charging and discharging of respective storage batteries of a plurality of electric-powered vehicles and thereby controls a timing for consuming system power. Thus, without the need to install a large-scale storage battery in a store or the like, leveling of power consumption can be achieved.

### LIST OF CITATIONS

### Patent Literature

Patent Document 1: JP-A-2007-282383

Patent Document 2: JP-A-2009-183086

### SUMMARY OF THE INVENTION

### Technical Problem

In the power supply system proposed in each of Patent Document 1 and Patent Document 2, in order to level power consumption by controlling charging and discharging of the storage batteries, it is required that the electric-powered vehicles be constantly (or for at least not less than a given time period within a specific time zone) under control of the power supply system. For this reason, the above-described power supply system can hardly be applied unless it is used in a business facility or the like where each electric-powered vehicle is parked for a long time and a time period for which each electric-powered vehicle is parked is fixed beforehand.

To be more concrete, for example, in a store or the like where an electric-powered vehicle is frequently parked and started and a time period for which the electric-powered vehicle is parked is unfixed (a user of the electric-powered vehicle arbitrarily decides a parking time and a starting time of the electric-powered vehicle), a storage battery thereof cannot be kept under control. This makes it impossible to determine timings for charging and discharging the storage battery, rendering the use per se of the storage battery difficult.

In view of the above, it is an object of the present invention to provide a power supply system in which even under a situation where a storage battery in a controllable state may be frequently and indeterminately changed, said storage battery can be used with high reliability.

### Solution to the Problem

In order to achieve the above-described object, a power supply system according to the present invention includes: a timing determination portion that determines a timing for performing at least one of charging and discharging of a storage battery that stores electric power by being charged and supplies electric power by being discharged; and a control-enabled time period estimation portion that estimates a control-enabled time period in which the timing determination portion can determine timings for charging and discharging the storage battery. In the power supply system, based on the control-enabled time period, the timing determination portion determines the timing for performing at least one of charging and discharging of the storage battery.

Furthermore, the power supply system configured as above may have the following configuration. That is, the power supply system further includes a time period setting portion that sets at least one of a recommended charging time period in which the storage battery should be charged and a recommended discharging time period in which the storage battery should be discharged. In a case where the recommended charging time period is set, the timing determination portion can set at least part of an overlapping time period between the control-enabled time period and the recommended charging time period as a timing at which the storage battery is charged, and in a case where the recommended discharging time period is set, the timing determination portion can set at least part of an overlapping time period between the control-enabled time period and the recommended discharging time period as a timing at which the storage battery is discharged.

According to this configuration, it is possible to charge a storage battery in a chargeable state in a time period in which it should be charged and to discharge a storage battery in a dischargeable state in a time period in which it should be discharged. This allows efficient use of a storage battery.

Furthermore, the power supply system configured as above may have the following configuration. That is, the power supply system further includes a load amount estimation portion that estimates the amount of electric power to be supplied to a load by the power supply system. The time period setting portion sets as the recommended discharging time period, a time period in which, by the load amount estimation portion, the amount of electric power to be supplied to the load by the power supply system is estimated to become larger than in other time periods.

According to this configuration, the maximum value of the amount of electric power consumed per unit time period is decreased, and thus power consumption can be leveled. This can reduce the electric power cost (base rate) of system power. Moreover, this allows a power company to perform efficient power generation and thus can reduce the amount of carbon dioxide emitted as a result of the power generation.

Furthermore, the power supply system configured as above may have the following configuration. That is, the power supply system can use system power supplied from a power company, and the time period setting portion sets as the recommended discharging time period, a time period in which a cost per unit amount of the system power is high and as the recommended charging time period, a time period in which the cost per unit amount of the system power is low.

According to this configuration, by selling electric power supplied by discharging the storage battery, it is possible to make a profit efficiently. Furthermore, in a case where electric power supplied by discharging the storage battery is consumed by a load or the like, the electric power cost (usage-based rate) of system power can be reduced. Moreover, electric power is consumed (the storage battery is charged) in a time period in which the usage-based rate of system power is set to be low by a power company, and electric power is supplied (the storage battery is discharged) in a time period in which the usage-based rate is set to be high by the power company, and thus power consumption can be leveled. This allows a power company to perform efficient power generation and thus can reduce the amount of carbon dioxide emitted as a result of the power generation.

Furthermore, the power supply system configured as above may have the following configuration. That is, the timing determination portion determines timings for charging and discharging the storage battery so that both of discharging of said storage battery and charging thereof in which electric power in an amount substantially equal to the amount of electric power that is supplied by said discharging of the storage battery is stored into said storage battery are performed in the control-enabled time period.

According to this configuration, it is possible to eliminate a gain/loss in the amount of electric power of the storage battery. This can reduce the feeling of uneasiness in both of a user of the storage battery and a user of the power supply system about charging and discharging of the storage battery being controlled and thus can encourage the use of the power supply system.

Furthermore, the power supply system configured as above may have the following configuration. That is, the storage battery is provided in an electric-powered vehicle, and based on a time period for which the electric-powered vehicle is intended to be parked, the control-enabled time period estimation portion estimates the control-enabled time period of the storage battery.

According to this configuration, the storage battery of an electric-powered vehicle that can be switched between a controllable state and an uncontrollable state can be used with high reliability.

Furthermore, the power supply system configured as above may have the following configuration. That is, the timing determination portion makes at least one of a determination that timings for charging a plurality of storage batteries are shifted from each other and a determination that timings for discharging the plurality of storage batteries are shifted from each other.

According to this configuration, power consumption can be leveled effectively.

Furthermore, the power supply system configured as above may have the following configuration. That is, depending on a remaining capacity of the storage battery, the timing determination portion determines whether or not at least one of charging and discharging is to be executed.

This configuration can prevent excessive charging and excessive discharging of the storage battery, which places a burden on the storage battery.

Furthermore, the power supply system configured as above may have a configuration in which remuneration is given to the user of the storage battery.

This configuration can reduce the feeling of uneasiness in the user of the storage battery about authorizing the power supply system to control charging and discharging of the storage battery and thus allows power consumption to be leveled effectively.

### Advantageous Effects of the Invention

According to the configuration of the present invention, a time period in which control of the storage battery is enabled is estimated, and based on a result of the estimation, a charging timing and/or a discharging timing are determined. Thus, even under a situation where the storage battery in the controllable state may be frequently and indeterminately changed, timings for charging and/or discharging the storage battery can be determined, so that the storage battery can be used with high reliability.

The significance and effects of the present invention will become further apparent from the following description of an embodiment of the invention. It is to be understood, however, that the following embodiment is merely an example of how the invention is implemented, and that the meanings of the terms used to describe the invention and its constituent components are not limited to those used in the following description of the embodiment.

### BRIEF DESCRIPTION OF DRAWINGS

FIG. 1 A block diagram showing a configuration example of a power supply system as one embodiment of the present invention.

FIG. 2 A block diagram showing a configuration example of a charging/discharging control section shown in FIG. 1.

FIG. 3 A flow chart showing an operation example of the power supply system shown in FIG. 1.

FIG. 4 A diagram showing a charging/discharging control pattern of Type 1.

FIG. 5 A diagram showing a charging/discharging control pattern of Type 2.

FIG. 6 A diagram showing a charging/discharging control pattern of Type 3.

FIG. 7 A diagram showing a charging/discharging control pattern of Type 4.

FIG. 8 A diagram showing one example of a result provided by the operation example of the power supply system shown in FIG. 3.

FIG. 9 A block diagram showing another application example of the power supply system as the one embodiment of the present invention.

FIG. 10 A block diagram showing a configuration example of the power supply system as the one embodiment of the present invention.

FIG. 11 A flow chart showing an operation example of the power supply system shown in FIG. 10.

### DESCRIPTION OF EMBODIMENT

### Working Example 1

<Power Supply System>

The following describes a power supply system as one embodiment of the present invention with reference to the appended drawings. In order to make the description more concrete, there is exemplarily described a power supply system that uses a storage battery provided in an electric-powered vehicle such as an electric-powered automobile, an electric-powered motorbike, or the like (which may encompass vehicles that use electric power in combination with power of any other type such as of a gasoline engine or the like; the same applies in the following).

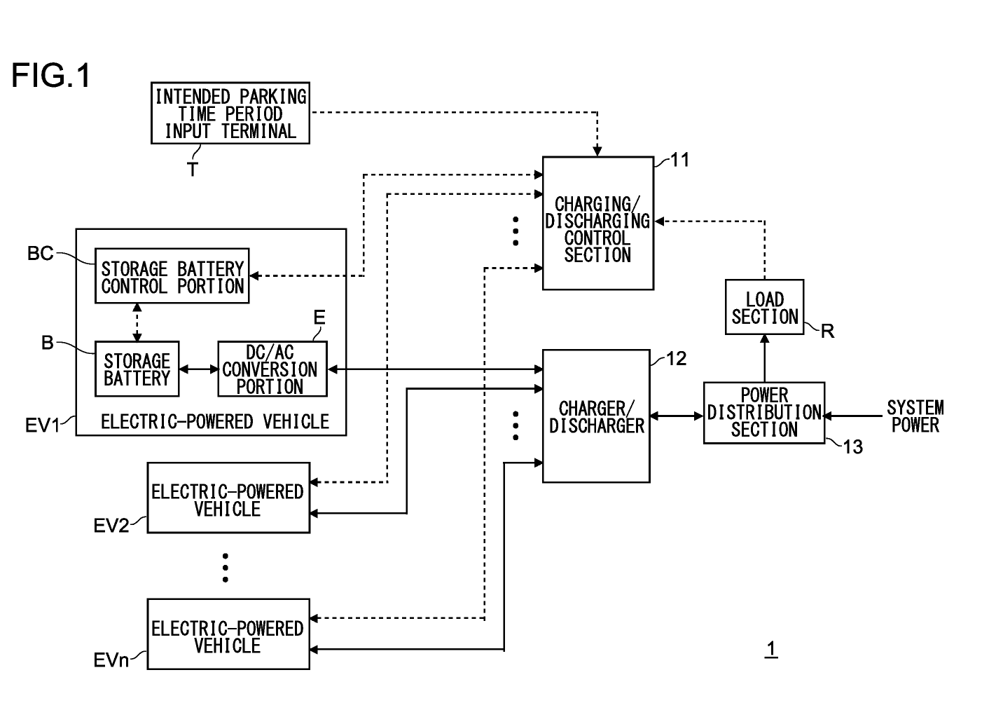

FIG. 1 is a block diagram showing a configuration example of the power supply system as the one embodiment of the present invention. In FIG. 1, for the sake of simplicity of the description, it is assumed that electric-powered vehicles each denoted EVn (n indicates a natural number) are all identical in configuration. In this figure, a configuration of an electric-powered vehicle EV1 is representatively shown, and configurations of the other electric-powered vehicles EVn are therefore omitted. In FIG. 1, each solid line arrow indicates exchange of electric power, and each broken line arrow indicates exchange of information. Furthermore, while FIG. 1 assumes that at least three or more electric-powered vehicles are present, there may be a case where the number of electric-powered vehicles is two or less.

A power supply system 1 shown in FIG. 1 includes a charging/discharging control section 11 that controls timings for charging and discharging a storage battery B of the electric-powered vehicle EVn, a charger/discharger 12 that is connected to the electric-powered vehicle EVn to supply it with electric power to be charged into the storage battery B and to which electric power discharged from the storage battery B is supplied, and a power distribution section 13 that supplies electric power supplied from the charger/discharger 12 and system power to a load section R and supplies system power to the charger/discharger 12.

The electric-powered vehicle EVn includes the storage battery B that stores supplied electric power by being charged and supplies electric power by being discharged, a storage battery control portion BC that is controlled by the charging/discharging control section 11 to perform charging and discharging of the storage battery B, and a DC/AC conversion portion E that converts electric power (for example, alternating current power) supplied from the charger/discharger 12 into electric power (for example, direct current power) that can be charged into the storage battery B and converts electric power (for example, direct current power) supplied by discharging the storage battery B into electric power (for example, alternating current power) that can be consumed by the load section R.

The storage battery control portion BC not only performs charging and discharging of the storage battery B but also estimates the amount of electric power charged (hereinafter, referred to as a remaining capacity) in the storage battery B. For example, the storage battery control portion BC includes a table indicating a relationship between a voltage value of the storage battery B and a remaining capacity thereof and estimates a remaining capacity by measuring a voltage value of the storage battery B and by referring to said table with respect to the voltage value thus measured. Furthermore, for example, the storage battery control portion BC estimates a remaining capacity by monitoring the amount of electric power or an electric current charged into the storage battery B and the amount of electric power or an electric current discharged from the storage battery B. Furthermore, the storage battery control portion BC notifies the charging/discharging control section 11 of an estimated remaining capacity of the storage battery B and of identification information of the electric-powered vehicle EVn (this information can be construed also as identification information of the storage battery B; the same applies in the following). This allows the charging/discharging control section 11 to grasp the remaining capacity thus notified of in relation to the storage battery B.

The load section R is composed of a plurality of devices (loads) that consume electric power supplied from the power distribution section 13, examples of which may include devices in general provided in a store or the like, including an illumination device such as an electric light or the like, an air conditioner, a cooling device, a heating device, and so on. Furthermore, the load section R checks electric power consumed by the entire loads (hereinafter, referred to as a load amount) on an individual basis or as a whole and notifies the charging/discharging control section 11 of a result of the checking.

An intended parking time period input terminal T is constituted by, for example, a portable terminal such as a mobile phone or the like, which is owned by a user of the electric-powered vehicle EVn (this user can be construed also as a user of the storage battery B; the same applies in the following), a terminal provided in the electric-powered vehicle EVn, a terminal provided at a parking lot (for example, a terminal belonging to the charger/discharger 12), or the like. For example, at the time of parking the electric-powered vehicle EVn, the user of the electric-powered vehicle EVn inputs a time period for which he/she intends to park the electric-powered vehicle EVn (hereinafter, referred to as an intended parking time period) into the intended parking time period input terminal T. Furthermore, the intended parking time period input terminal T notifies the charging/discharging control section 11 of an inputted intended parking time period and of identification information of the electric-powered vehicle EVn. This allows the charging/discharging control section 11 to grasp the intended parking time period thus notified of in relation to the storage battery B.

To be more concrete, for example, the user of the electric-powered vehicle EVn inputs a start time and an end time of an intended parking time period into the intended parking time period input terminal T, and the intended parking time period input terminal T notifies the charging/discharging control section 11 of said times. The charging/discharging control section 11 may grasp a start time of an intended parking time period by detecting, for example, a time at which the intended parking time period is inputted via the intended parking time period input terminal T or a time at which the charging/discharging control section 11 and the charger/discharger 12 are connected to the electric-powered vehicle EVn. In this case, the length of the intended parking time period (for example, 30 minutes, one hour, or the like) or an end time of the intended parking time period may be inputted into the intended parking time period input terminal T.

Based on a remaining capacity of the storage battery B notified of from the storage battery control portion BC of the electric-powered vehicle EVn, an intended parking time period notified of from the intended parking time period input terminal T, a load amount notified of from the load section R, and so on, the charging/discharging control section 11 determines timings for charging and discharging the storage battery B. Details of the charging/discharging control section 11 will be described later.

The charger/discharger 12 is connected to the electric-powered vehicle EVn via a cable or the like so as to supply electric power to be charged into the storage battery B and receive electric power discharged by the storage battery B. The charger/discharger 12 may supply and receive electric power in a non-contact manner with respect to the storage battery B (for example, through variations in the electric field or the magnetic field, transmission and reception of electromagnetic waves, or light emission and reception). In either of these configurations, however, preferably, switching between the storage batteries B of the electric-powered vehicles EVn, which are to be charged and discharged, is performed without the need for a manual connection/disconnection operation (for example, plugging/unplugging of a cable for connection to the electric-powered vehicle EVn). To be more concrete, for example, preferably, by the charging/discharging control section 11 or the like, automatic switching of a circuit in the charger/discharger 12 is performed to switch between the storage batteries B of the electric-powered vehicles EVn, which are to be charged and discharged.

The power distribution section 13 supplies the charger/discharger 12 with system power to be charged into the storage battery B of the electric-powered vehicle EVn. The power distribution section 13 also supplies the load section R with system power and electric power discharged by the storage battery B of the electric-powered vehicle EVn, which originates from electric power supplied via the charger/discharger 12.

While in the configuration shown in FIG. 1, the DC/AC conversion portion E is provided in the electric-powered vehicle EVn, the DC/AC conversion portion E may be provided in the charger/discharger 12. Furthermore, while the power supply system 1 in FIG. 1 uses the storage battery B of the electric-powered vehicle EVn, preferably, there is provided a storage battery that is stationary (for example, always connected to the power distribution section 13). Furthermore, such a stationary storage battery may be used in a case where the storage battery B of the electric-powered vehicle EVn is unusable or for a particular purpose other than that of the storage battery B of the electric-powered vehicle EVn, or it may even be used in a similar manner to the storage battery B of the electric-powered vehicle EVn.

Furthermore, the intended parking time period input terminal T may automatically estimate an intended parking time period by, for example, referring to a parking time and an average parking time period at said parking time, and outputs the intended parking time period thus estimated to the charging/discharging control section 11. Furthermore, various intentions and commands of the user of the electric-powered vehicle EVn such as a refusal to accept control of charging and discharging of the storage battery B by the charging/discharging control section 11, a command to charge the storage battery B, and so on may be inputted into the charging/discharging control section 11 via the intended parking time period input terminal T.

Furthermore, while FIG. 1 assumes, for the sake of convenience, that there exist two connection systems (electric power and information), one established between each of the electric-powered vehicles EVn and the charging/discharging control section 11 and the other established between each of the electric-powered vehicles EVn and the charger/discharger 12, instead, connection may be established using a single cable that is separated inside thereof into cable segments with respect to the two connection systems. Furthermore, at least one of these two connection systems may be established in a non-contact manner.

Furthermore, though described to control timings for charging and discharging the storage battery B of the electric-powered vehicle EVn, the charging/discharging control section 11 may be configured to control a timing for performing either (for example, discharging) of charging and discharging. In order, however, to make the description more concrete, the following exemplarily describes a case where the charging/discharging control section 11 controls timings for performing both of charging and discharging of the storage battery B of the electric-powered vehicle EVn.

<Charging/discharging Control Section>

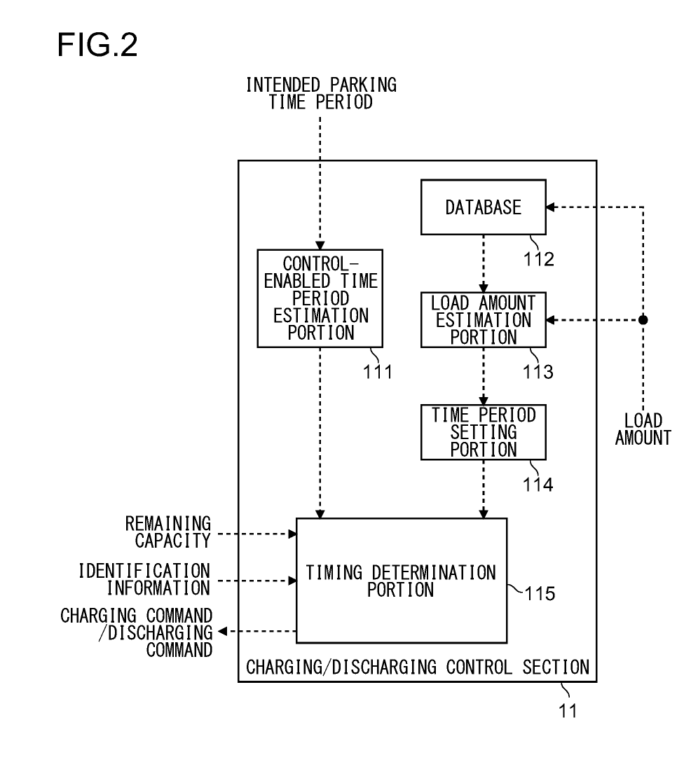

With reference to the appended drawings, a description is given of the charging/discharging control section 11 shown in FIG. 1. FIG. 2 is a block diagram showing a configuration example of the charging/discharging control section shown in FIG. 1. Similarly to FIG. 1, each broken line arrow in FIG. 2 also indicates exchange of information.

As shown in FIG. 2, the charging/discharging control section 11 includes a control-enabled time period estimation portion 111 that, based on an intended parking time period notified of from the intended parking time period input terminal T, estimates a time period in which control of timings for charging and discharging the storage battery B is enabled (hereinafter, referred to as a control-enabled time period), a database 112 in which a load amount notified of from the load section R is recorded, a load amount estimation portion 113 that predicts a load amount, based on data on a load amount read from the database 112 and on a load amount notified of from the load section R, a time period setting portion 114 that, based on a load amount estimated by the load amount estimation portion 113, sets a time period in which charging should be performed (hereinafter, referred to as a recommended charging time period) and a time period in which discharging should be performed (hereinafter, referred to as a recommended discharging time period), and a timing determination portion 115 that, based on a control-enabled time period estimated by the control-enabled time period estimation portion 111 and on a recommended charging time period and a recommended discharging time period set by the time period setting portion 114, determines timings for charging and discharging the storage battery B of the electric-powered vehicle EVn and commands the storage battery control portion BC to perform charging or discharging at said respective timings.

The control-enabled time period estimation portion 111 adopts, as an estimated control-enabled time period, a time period that is substantially equal to an intended parking time period. For the purpose of estimating a more reliable control-enabled time period, the control-enabled time period estimation portion 111 may adopt, as an estimated control-enabled time period, a time period that is shorter than an intended parking time period.

The database 112 records therein a load amount notified of from the load section R as data on a load amount per predetermined time period. Furthermore, the load amount estimation portion 113 estimates a future load amount, based on a current load amount that is inputted thereinto and on previous load amount data (which may encompass data statistically processed (for example, averaged for a predetermined period of time such as a week, a month, or the like)) read from the database 112.

Based on a load amount estimated by the load amount estimation portion 113, the time period setting portion 114 sets a recommended discharging time period and a recommended charging time period. For example, a time period in which a load amount is estimated to become larger than in other time periods (a time period in which the load amount reaches its peak) is set as a recommended discharging time period. A time period other than this recommended discharging time period may be set as a recommended charging time period. Furthermore, for example, a time period in which the electric power cost per unit amount of system power is low (for example, the nighttime) is set as a recommended charging time period, and a time period in which the cost per unit amount of system power (namely, the usage-based rate) is high (for example, the daytime) is set as a recommended discharging time period.

The timing determination portion 115 determines timings for charging and discharging the storage battery B on the premise that the storage battery B is charged and discharged in a control-enabled time period of the storage battery B estimated by the control-enabled time period estimation portion 111. To be more concrete, for example, if there is an overlapping time period between a control-enabled time period and a recommended charging time period, at least part of said time period is determined as a timing for charging the storage battery B. Furthermore, for example, if there is an overlapping time period between a control-enabled time period and a recommended discharging time period, at least part of said time period is determined as a timing for discharging the storage battery B.

The timing determination portion 115 outputs a charging command to the storage battery control portion BC at the thus determined timing for charging the storage battery B so as to perform charging of the storage battery B. Furthermore, for example, the timing determination portion 115 outputs a discharging command to the storage battery control portion BC at the thus determined timing for discharging the storage battery B so as to perform discharging of the storage battery B.

With the above-described configuration, a time period in which control of the storage battery B is enabled is estimated, and based on a result of the estimation, a charging timing and/or a discharging timing are determined. Thus, even under a situation where the storage battery B in a controllable state may be frequently and indeterminately changed, timings for charging and/or discharging the storage battery B can be determined, so that the storage battery B can be used with high reliability.

Moreover, the storage battery in a chargeable state can be charged in a time period in which it should be charged, and the storage battery in a dischargeable state can be discharged in a time period in which it should be discharged. This allows efficient use of the storage battery B.

The charging/discharging control section 11 may obtain information related to current or future weather conditions (for example, whether or not there is sunshine, an air temperature, a humidity, a precipitation amount, and so on) via a network or the like. Alternatively, the charging/discharging control section 11 may include an observation device that generates information related to weather conditions and obtain such information related to weather conditions from said observation device. The database 112 may then record therein the thus obtained information related to current weather conditions in relation to a load amount notified of from the load section R. Moreover, the load amount estimation portion 113 may estimate a future load amount by checking the information related to current weather conditions and by obtaining from the database 112 a load amount previously obtained under weather conditions similar thereto. This configuration makes it possible to estimate a load amount based on weather conditions and thus allows a load amount to be estimated with high accuracy.

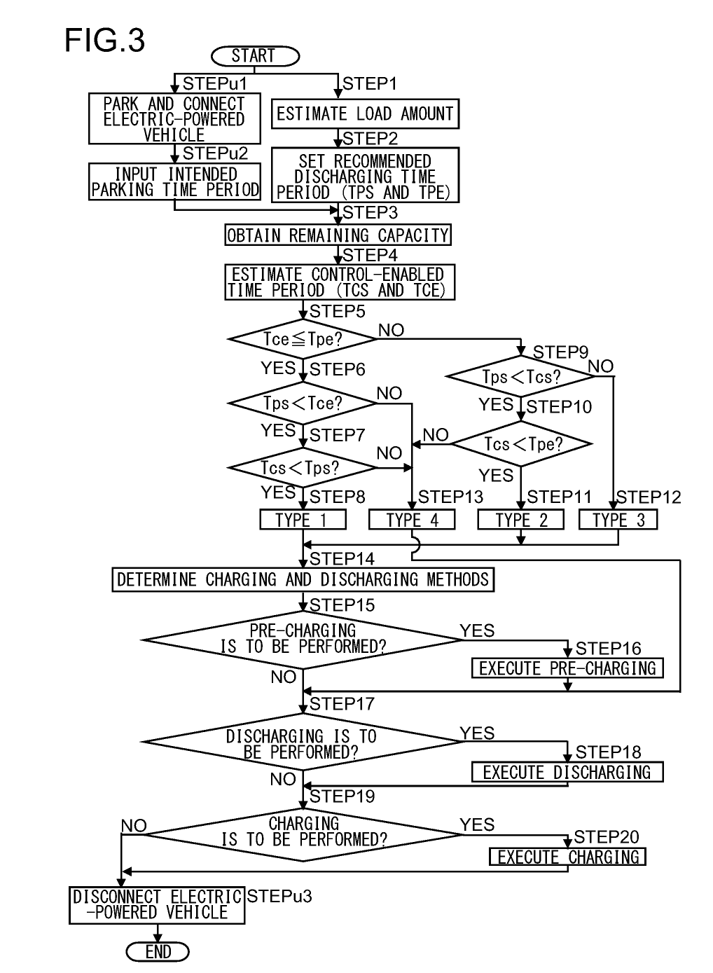

Furthermore, with reference to the appended drawings, a description is given of a concrete operation example of the power supply system 1 (particularly, the charging/discharging control section 11) of this example. FIG. 3 is a flow chart showing an operation example of the power supply system shown in FIG. 1. FIG. 3 shows a sequence of operations of the power supply system 1 from a step at which the electric-powered vehicle is brought under control of the power supply system 1 (it is parked and connected to the charger/discharger 12) to a step at which it is released from the control (it is disconnected).

As shown in FIG. 3, first, the user of the electric-powered vehicle EVn parks the electric-powered vehicle EVn in a predetermined parking space and connects the electric-powered vehicle EVn to the charger/discharger 12 (STEP u1). This enables the power supply system 1 to control charging and discharging of the storage battery B of the electric-powered vehicle EVn. Furthermore, the user of the electric-powered vehicle EVn inputs an intended parking time period into the charging/discharging control section 11 via the intended parking time period input terminal T (STEP u2).

Meanwhile, in the power supply system 1, as described above, the load amount estimation portion 113 estimates a future load amount (STEP 1). Then, based on the future load amount estimated by the load amount estimation portion 113, the time period setting portion 114 sets a recommended discharging time period. At this time, the time period setting portion 114 sets a start time Tps and an end time Tpe of the recommended discharging time period (STEP 2). In this operation example, it is assumed that the time period setting portion 114 sets as the recommended discharging time period, a time period in which a load amount is estimated to become larger than in other time periods (a time period in which the load amount reaches its peak). Furthermore, the operations at STEP 1 and STEP 2 may be executed regardless of whether or not the electric-powered vehicle EVn is connected to the charger/discharger 12.

Furthermore, the timing determination portion 115 obtains a remaining capacity of the storage battery B of the electric-powered vehicle EVn, whose control has been enabled (STEP 3). Moreover, based on the intended parking time period inputted via the intended parking time period input terminal T, the control-enabled time period estimation portion 111 estimates a control-enabled time period of the storage battery B. At this time, the control-enabled time period estimation portion 114 sets a start time Tcs and an end time Tce of the control-enabled time period (STEP 4). The user of the electric-powered vehicle EVn may designate the start time Tcs and the end time Tce of the control-enabled time period.

Based on relationships between the start time Tps and the end time Tpe of the recommended discharging time period and the start time Tcs and the end time Tce of the control-enabled time period, which have been set as described above, the timing determination portion 115 determines timings for charging and discharging the storage battery B.

First, in a case where the end time Tce of the control-enabled time period coincides with or is earlier than the end time Tpe of the recommended discharging time period (STEP 5, YES), the start time Tps of the recommended discharging time period is earlier than the end time Tce of the control-enabled time period (STEP 6, YES), and the start time Tcs of the control-enabled time period is earlier than the start time Tps of the recommended discharging time period (STEP 7, YES), the timing determination portion 115 determines to perform charging and discharging of the storage battery B in accordance with a charging/discharging control pattern of Type 1 (STEP 8).

Charging/discharging control patterns of various types are pattern types into which the timing determination portion 115 broadly categorizes timings for charging and discharging the storage battery B and can be construed also as guidelines for determining timings. Each of the charging/discharging control patterns of various types may define whether or not charging and discharging of the storage battery B are to be executed, the order in which the charging and discharging of the storage battery B are to be performed, and so on.

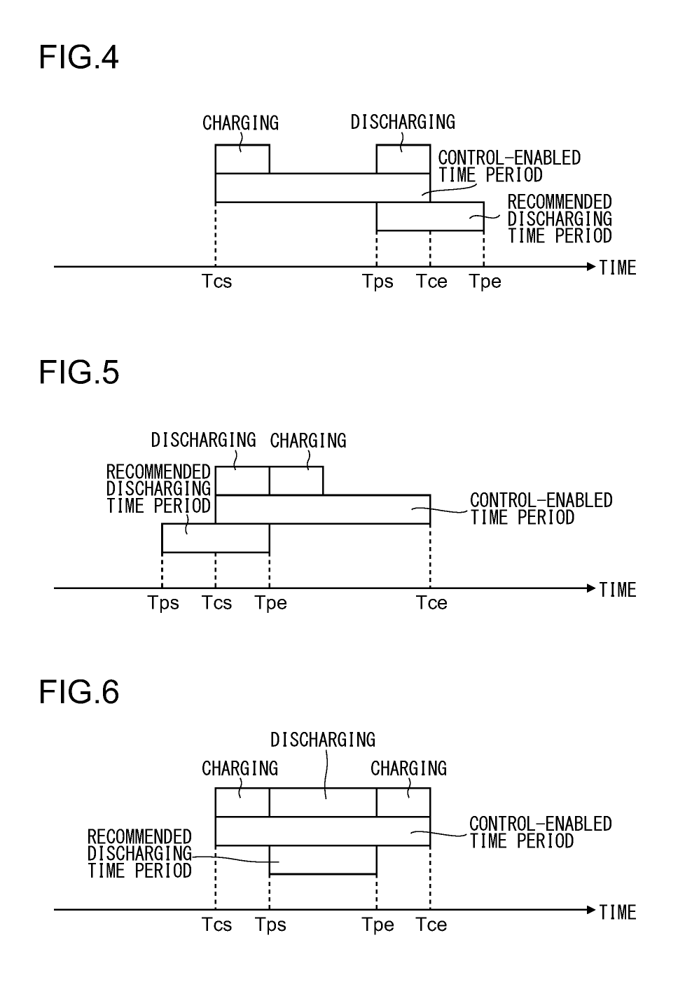

With reference to the appended drawings, a description is given of the charging/discharging control pattern of Type 1. FIG. 4 is a diagram showing the charging/discharging control pattern of Type 1. In a case where the charging/discharging control pattern of Type 1 is selected, the above-described relationships between the control-enabled time period and the recommended discharging time period are satisfied. At this time, at a later part of the control-enabled time period, there exists an overlapping time period between the control-enabled time period and the recommended discharging time period. In the charging/discharging control pattern of Type 1, discharging of the storage battery B is performed in the whole or part of this overlapping time period. Moreover, charging of the storage battery B is performed in the whole or part of a part of the control-enabled time period earlier than this overlapping time period.

In a case where the end time Tce of the control-enabled time period is later than the end time Tpe of the recommended discharging time period (STEP 5, NO), the start time Tps of the recommended discharging time period is earlier than the start time Tcs of the control-enabled time period (STEP 9, YES), and the start time Tcs of the control-enabled time period is earlier than the end time Tpe of the recommended discharging time period (STEP 10, YES), the timing determination portion 115 determines to perform charging and discharging of the storage battery B in accordance with a charging/discharging control pattern of Type 2 (STEP 11).

With reference to the appended drawings, a description is given of the charging/discharging control pattern of Type 2. FIG. 5 is a diagram showing the charging/discharging control pattern of Type 2. In a case where the charging/discharging control pattern of Type 2 is selected, the above-described relationships between the control-enabled time period and the recommended discharging time period are satisfied. At this time, at an earlier part of the control-enabled time period, there exists an overlapping time period between the control-enabled time period and the recommended discharging time period. In the charging/discharging control pattern of Type 2, discharging of the storage battery B is performed in the whole or part of this overlapping time period. Moreover, charging of the storage battery B is performed in the whole or part of a part of the control-enabled time period later than this overlapping time period.

In a case where the end time Tce of the control-enabled time period is later than the end time Tpe of the recommended discharging time period (STEP 5, NO), and the start time Tps of the recommended discharging time period coincides with or is later than the start time Tcs of the control-enabled time period (STEP 9, NO), the timing determination portion 115 determines to perform charging and discharging of the storage battery B in accordance with a charging/discharging control pattern of Type 3 (STEP 12).

With reference to the appended drawings, a description is given of the charging/discharging control pattern of Type 3. FIG. 6 is a diagram showing the charging/discharging control pattern of Type 3. In a case where the charging/discharging control pattern of Type 3 is selected, the above-described relationships between the control-enabled time period and the recommended discharging time period are satisfied. At this time, there exists an overlapping time period between the control-enabled time period and the recommended discharging time period, and before and after this overlapping time period, there exist parts of the control-enabled time period (the control-enabled time period encompasses the recommended discharging time period). In the charging/discharging control pattern of Type 3, discharging of the storage battery B is performed in the whole or part of this overlapping time period. Moreover, charging of the storage battery B is performed in the whole or part of each of the parts of the control-enabled time period before and after this overlapping time period.

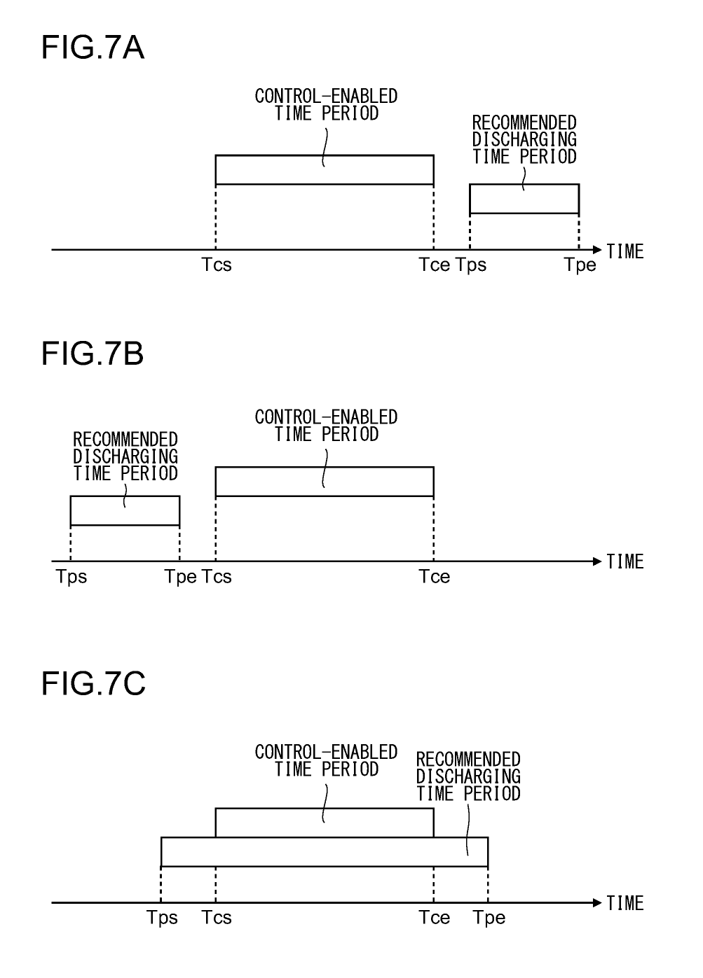

By the way, in a case where the end time Tce of the control-enabled time period coincides with or is earlier than the end time Tpe of the recommended discharging time period (STEP 5, YES), and the start time Tps of the recommended discharging time period coincides with or is later than the end time Tce of the control-enabled time period (STEP 6, NO), the timing determination portion 115 determines to adopt a charging/discharging control pattern of Type 4 (FIG. 7(a), which will be described later) (STEP 13).

Similarly to the above, also in a case where the end time Tce of the control-enabled time period is later than the end time Tpe of the recommended discharging time period (STEP 5, NO), the start time Tps of the recommended discharging time period is earlier than the start time Tcs of the control-enabled time period (STEP 9, YES), and the start time Tcs of the control-enabled time period coincides with or is later than the end time Tpe of the recommended discharging time period (STEP 10, NO), the timing determination portion 115 determines to adopt the charging/discharging control pattern of Type 4 (FIG. 7(b), which will be described later) (STEP 13).

Moreover, similarly to the above, also in a case where the end time Tce of the control-enabled time period coincides with or is earlier than the end time Tpe of the recommended discharging time period (STEP 5, YES), the start time Tps of the recommended discharging time period is earlier than the end time Tce of the control-enabled time period (STEP 6, YES), and the start time Tcs of the control-enabled time period coincides with or is later than the start time Tps of the recommended discharging time period (STEP 7, NO), the timing determination portion 115 determines to adopt the charging/discharging control pattern of Type 4 (FIG. 7(c), which will be described later) (STEP 13).

With reference to the appended drawings, a description is given of the charging/discharging control pattern of Type 4. FIG. 7 is a diagram showing the charging/discharging control pattern of Type 4. The charging/discharging control pattern of Type 4 is a type in which either of a discharging timing and a charging timing cannot be determined

To be more concrete, Type 4 subsumes types in which, as shown in FIGS. 7(a) and 7(b), there exists no overlapping time period between the control-enabled time period and the recommended discharging time period, which makes it impossible to determine a discharging timing (discharging cannot be performed effectively and thus is hardly demanded). In this case, for example, if desired by the user of the electric-powered vehicle EVn, charging of the storage battery B may be performed in part or the whole of the control-enabled time period. At this time, a user of the power supply system 1 may receive remuneration (in the form of, for example, money, a coupon or a service ticket offering a discount or the like, loyalty points awarded by a store to their customers, or the like; the same applies in the following) from the user of the electric-powered vehicle EVn.

Furthermore, Type 4 also subsumes a type in which, as shown in FIG. 7(c), the control-enabled time period entirely overlaps the recommended discharging time period (the recommended discharging time period encompasses the control-enabled time period), which makes it impossible to determine a charging timing (charging possibly results in a further increase in load amount). In this case, for example, if permitted by the user of the electric-powered vehicle EVn, discharging of the storage battery B may be performed in part or the whole of the control-enabled time period. At this time, the user of the power supply system 1 may give remuneration to the user of the electric-powered vehicle EVn.

In each of cases where the charging/discharging control patterns of Types 1 to 3 are determined to be adopted at STEPs 8, 11, and 12, respectively, the timing determination portion 115 determines charging and discharging methods (for example, amounts of electric power to be charged and discharged, respectively, and details of charging and discharging timings) (STEP 14). Herein, for the sake of simplicity of the description, it is assumed that the storage battery B has such a remaining capacity as to allow both of charging and discharging to be performed.

At this time, preferably, the timing determination portion 115 determines the timings so that the amount of electric power to be discharged from the storage battery B is substantially equal to the amount of electric power to be charged into the storage battery B. This is preferable in that it can eliminate a gain/loss in the amount of electric power of the storage battery B. This configuration can reduce the feeling of uneasiness in both of the user of the electric-powered vehicle EVn and the user of the power supply system 1 about charging and discharging of the storage battery B being controlled and thus can encourage the use of the power supply system 1.

Furthermore, at this time, preferably, the timing determination portion 115 takes into consideration, in determining details of the charging and discharging timings, timings for charging and discharging any other storage battery(ies) B. To be more concrete, for example, preferably, respective timings for charging a plurality of storage batteries B are determined such that they are shifted as much as possible so as not to coincide with each other. Similarly, preferably, respective timings for discharging a plurality of storage batteries B are determined such that they are shifted as much as possible so as not to coincide with each other. This configuration allows power consumption to be leveled effectively.

Upon determining the charging and discharging methods at STEP 14, the timing determination portion 115 outputs a charging command and a discharging command to the storage battery control portion BC so that electric power is charged into and discharged from the storage battery B in the respective amounts at the respective timings, which have thus been determined.

First, in a case where a type has been determined to be adopted in which, as in the charging/discharging control patterns of Type 1 and Type 3, charging (pre-charging) is performed prior to discharging, the timing determination portion 115 stays on standby until the timing for performing pre-charging determined at STEP 14 has been reached. Upon ascertaining that the above-described timing has been reached (STEP 15, YES), the timing determination portion 115 outputs a charging command to the storage battery control portion BC so as to execute the pre-charging of the storage battery B (STEP 16).

After completion of the pre-charging at STEP 16, or in a case where a type has been determined to be adopted in which, as in the charging/discharging control pattern of Type 2, pre-charging is not performed (STEP 15, NO), the timing determination portion 115 stays on standby until the timing for performing discharging determined at STEP 14 has been reached. Upon ascertaining that the above-described timing has been reached (STEP 17, YES), the timing determination portion 115 outputs a discharging command to the storage battery control portion BC so as to execute the discharging of the storage battery B (STEP 18). Also in a case where the timing determination portion 115 has determined to adopt the charging/discharging control pattern of Type 4 and performs discharging, the discharging is performed at the timing determined by the timing determination portion 115.

After completion of the discharging at STEP 18, or in a case where discharging is not performed in the charging/discharging control pattern of Type 4 (STEP 17, NO), the timing determination portion 115 stays on standby until the timing for performing charging determined at STEP 14 has been reached. Upon ascertaining that the above-described timing has been reached (STEP 19, YES), the timing determination portion 115 outputs a charging command to the storage battery control portion BC so as to execute the charging of the storage battery B (STEP 20). Also in a case where the timing determination portion 115 has determined to adopt the charging/discharging control pattern of Type 4 and performs charging, the charging is performed at the timing determined by the timing determination portion 115.

After completion of the charging at STEP 20, or in either of a case where a type has been determined to be adopted in which, as in the charging/discharging control pattern of Type 1, post-discharge charging is not performed and a case where charging is not performed in the charging/discharging control pattern of Type 4 (STEP 19, NO), at an arbitrary timing, the user of the electric-powered vehicle EVn disconnects the electric-powered vehicle EVn from the charger/discharger 12 in order that the electric-powered vehicle EVn can be started (STEP u3). This disables the power supply system 1 from controlling charging and discharging of the storage battery B of the electric-powered vehicle EVn, thus completing the operations with respect to the storage battery B.

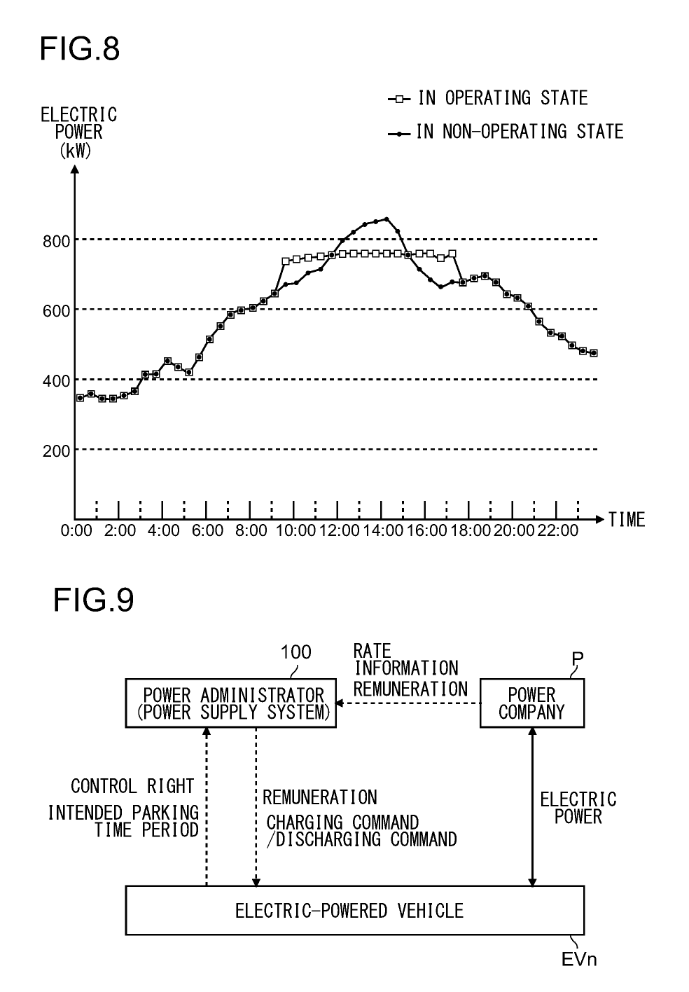

With reference to the appended drawings, a description is given of a result provided by the operation example of the power supply system 1 shown in FIG. 3. FIG. 8 is a diagram showing one example of the result of the operation example of the power supply system shown in FIG. 3. In the example shown in FIG. 8, when the power supply system 1 is in a non-operating state, in a time period between about 12:00 and 14:30, a load amount markedly increases to the order of 850 kW.

As shown in FIG. 8, when the power supply system 1 is in an operating state, in a time period between about 12:00 and about 14:30 (i.e. the recommended discharging time period), discharging of the storage battery B is performed. This can reduce the load amount in said time period to the order of 750 kW. In time periods before and after said time period between about 9:00 and about 17:00, however, charging of the storage battery B is performed, so that the load amount in each of these time periods increases. It is not required that, in a time period between about 9:00 and about 17:00 in which the power supply system 1 controls charging and discharging of the storage battery B, all the storage batteries B be continuously in the controllable state. As described in the foregoing operation example, with the power supply system 1 of this example, even if the storage battery B in the controllable state is changed, charging and discharging of the storage battery B can be performed.

With this configuration, the power supply system 1 operates to decrease the maximum value of the amount of electric power consumed per unit time period, and thus power consumption can be leveled. This can reduce the electric power cost (base rate) of system power. For example, assuming that a monthly base rate is calculated based on 1,500 yen per 1 kW of load amount at its peak, in the example shown in FIG. 8, the load amount at its peak can be reduced by about 100 kW, and thus a monthly cost reduction on the order of 150,000 yen and an annual cost reduction on the order of 1.8 million yen can be achieved. Furthermore, this allows a power company to perform efficient power generation and thus can reduce the amount of carbon dioxide emitted as a result of the power generation.

Preferably, as an incentive to allow the user of the power supply system 1 to control charging and discharging of the storage battery B, the user of the power supply system 1 gives remuneration to the user of the electric-powered vehicle EVn. This is preferable in that it can reduce the feeling of uneasiness in the user of the electric-powered vehicle EVn about authorizing the power supply system 1 to control charging and discharging of the storage battery B. This allows power consumption to be leveled effectively.

Furthermore, the user of the power supply system 1 may sets a value of remuneration to be given to the user of the electric-powered vehicle EVn so that the longer the user of the electric-powered vehicle EVn sets a time period in which control of the storage battery B is enabled to be (the longer he/she parks the electric-powered vehicle EVn), the higher the value of remuneration is. This configuration can increase the number of the storage batteries B, each of which has been set to have a long control-enabled time period and thus can be charged and discharged efficiently.

Furthermore, in a case where, as a result of the power supply system 1 controlling charging and discharging of the storage battery B, there occurs a variation in remaining capacity of the storage battery B, the user of the power supply system 1 may give to or receive from the user of the electric-powered vehicle EVn remuneration of a value corresponding to said variation. For example, in a case where, as a result of the power supply system 1 controlling charging and discharging of the storage battery B, there occurs a decrease in remaining capacity of the storage battery B, the user of the power supply system 1 may give remuneration of a value corresponding to said decrease to the user of the electric-powered vehicle EVn. Furthermore, for example, in a case where, as a result of the power supply system 1 controlling charging and discharging of the storage battery B, there occurs an increase in remaining capacity of the storage battery B, the user of the power supply system 1 may receive remuneration of a value corresponding to said increase from the user of the electric-powered vehicle EVn.

Furthermore, although at STEP 14, it is assumed that the storage battery B has such a remaining capacity as to allow both of charging and discharging to be performed, in some situation, the actual remaining capacity thereof may not apply thereto. In case of such a situation, the timing determination portion 115 may perform control, depending on a remaining capacity of the storage battery B, as to whether or not charging and discharging are to be executed and amounts of electric power to be charged and discharged, respectively. For example, in a case where the timing determination portion 115 has determined to adopt the charging/discharging control pattern of Type 1 or Type 3, upon ascertaining that the storage battery B has a sufficient remaining capacity (for example, not less than 90%), the timing determination portion 115 may determine not to perform pre-charging. Furthermore, for example, in a case where the timing determination portion 115 has determined to adopt the charging/discharging control pattern of Type 2, upon ascertaining that there is almost no remaining capacity (for example, not more than 10%), the timing determination portion 115 may determine not to perform discharging. This configuration can prevent excessive charging and excessive discharging of the storage battery B, which place a burden on the storage battery B.

Furthermore, in a case where at STEP 14, the timing determination portion 115 ascertains that a time period in which charging at STEP 16 or STEP 20 can be performed (a time period within the control-enabled time period, which does not overlap the recommended discharging time period) is short, the timing determination portion 115 may determine to perform fast charging (charging in which the amount of electric power supplied per unit time period is set to be larger than in normal charging). In a case, however, where fast charging possibly results in the maximum value of a load amount being exceeded, preferably, normal charging or charging in which the amount of electric power to be supplied is set to be between the amount of electric power supplied in normal charging and the amount of electric power supplied in fast charging is performed.

### Modified Example

While the foregoing has mainly described an application example of the power supply system 1 that can achieve a reduction in base rate of system power, the power supply system 1 is applicable also as a power supply system that achieves a reduction in usage-based rate (a cost per unit amount of electric power) of system power. With reference to the appended drawings, a description is given of an application example of this type of power supply system. FIG. 9 is a block diagram showing an application example of the power supply system as the one embodiment of the present invention. Also in FIG. 9, similarly to FIGS. 1 and 2, each solid line arrow indicates exchange of electric power, and each broken line arrow indicates exchange of information or remuneration.

As shown in FIG. 9, similarly to the case of FIG. 1, a power administrator 100 having a configuration similar to that of the power supply system 1 shown in FIG. 1 obtains, from the user of the electric-powered vehicle EVn, an intended parking time period and a right (control right) for allowing it to control charging and discharging of the storage battery B. Here, however, the electric-powered vehicle EVn is not limited to one that is parked at a parking lot of a store or the like and may be one that is parked at an individual house. Furthermore, as an incentive for the user of the electric-powered vehicle EVn to allow the power administrator 100 to control the storage battery B (to issue a charging command and a discharging command), the power administrator 100 gives remuneration to the user of the electric-powered vehicle EVn.

Based on information on the electric power cost (rate information) of a power company P, the power administrator 100 grasps time periods in which the usage-based rate of system power is low and high, respectively. Then, the power administrator 100 sets the time period in which the usage-based rate is low as a recommended charging time period and the time period in which the usage-based rate is high as a recommended discharging time period. Similarly to the foregoing power supply system 1, the power administrator 100 then determines timings for charging and discharging the storage battery B of the electric-powered vehicle EVn and performs the charging and discharging of the storage battery B at said timings. In this case, however, electric power supplied by discharging the storage battery B of the electric-powered vehicle EVn is sold to the power company P. This allows the power administrator 100 to gain from the power company P, for example, remuneration (a profit) based on a difference in usage-based rate. As described above, part of said remuneration is given to the user of the electric-powered vehicle EVn.

With this configuration, by applying the foregoing power supply system 1 thereto, charging and discharging of the storage batteries B of a multitude of electric-powered vehicles EVn can be controlled efficiently. This allows the power administrator 100 to make a profit efficiently. Furthermore, in a case where electric power supplied by discharging the storage battery B is not sold but consumed by a load or the like, the electric power cost (usage-based rate) of system power can be reduced.

Moreover, electric power is consumed (the storage battery B is charged) in a time period in which the usage-based rate of system power is set to be low by the power company P, and electric power is supplied (the storage battery B is discharged) in a time period in which the usage-based rate is set to be high by the power company P, and thus power consumption can be leveled. This allows the power company P to perform efficient power generation and thus can reduce the amount of carbon dioxide emitted as a result of the power generation.

Furthermore, the present invention is applicable not only to the purpose of reducing the electric power cost of system power but also to, for example, a power supply system that fulfills various purposes that can be achieved by the V2G (vehicle-to-grid) technology. As one example, the present invention is applicable to a stabilization power source that supplies electric power when the frequency of system power becomes unstable due to an abrupt variation in power demand or the like or to an emergency power source that supplies electric power when the supply of system power is halted in a case of a disaster or the like.

Furthermore, while the foregoing has mainly described the power supply system 1 that uses the storage battery B provided in the electric-powered vehicle EVn, a power supply system that uses a storage battery provided in something else may be adopted. In this case, however, favorable is a power supply system that uses such a storage battery that, similarly to the storage battery B provided in the electric-powered vehicle EVn, estimating a control-enabled time period thereof provides a practical benefit (a storage battery that can be switched between a controllable state and an uncontrollable state).

The power supply system 1 according to the one embodiment of the present invention may be configured so that part or all of the operations of the charging/discharging control section 11 and so on are performed by a control apparatus such as a microcomputer. Moreover, a configuration also may be adopted in which all or part of functions that are achieved by such a control apparatus are written as a program, and the all or part of functions are achieved by executing said program on a program execution apparatus (for example, a computer).

Furthermore, not only in the above-described case but in other cases as well, the power supply system 1 shown in FIG. 1 and the charging/discharging control section 11 shown in FIG. 2 can be realized by hardware or a combination of hardware and software. Furthermore, in a case where a charging system is made up partly of software, it is assumed that a block in a section realized by the software represents a functional block in that section.

### Working Example 2

A description is given of a working example regarding control that takes into consideration a measure to deal with a case where there occurs a shortage in capacity of the storage battery B of the electric-powered vehicle EVn, which is in a controllable state.

The “case where there occurs a shortage in capacity of the storage battery B of the electric-powered vehicle EVn, which is in a controllable state” refers to, for example, a case where, after the user who parked the electric-powered vehicle EVn at a parking lot of a store has initially set an “intended parking time period” to three hours, for some reason such as the user's convenience or the like, it turns out that the electric-powered vehicle EVn has to leave there after two hours of parking. In such a case, control on a system side is performed as follows.

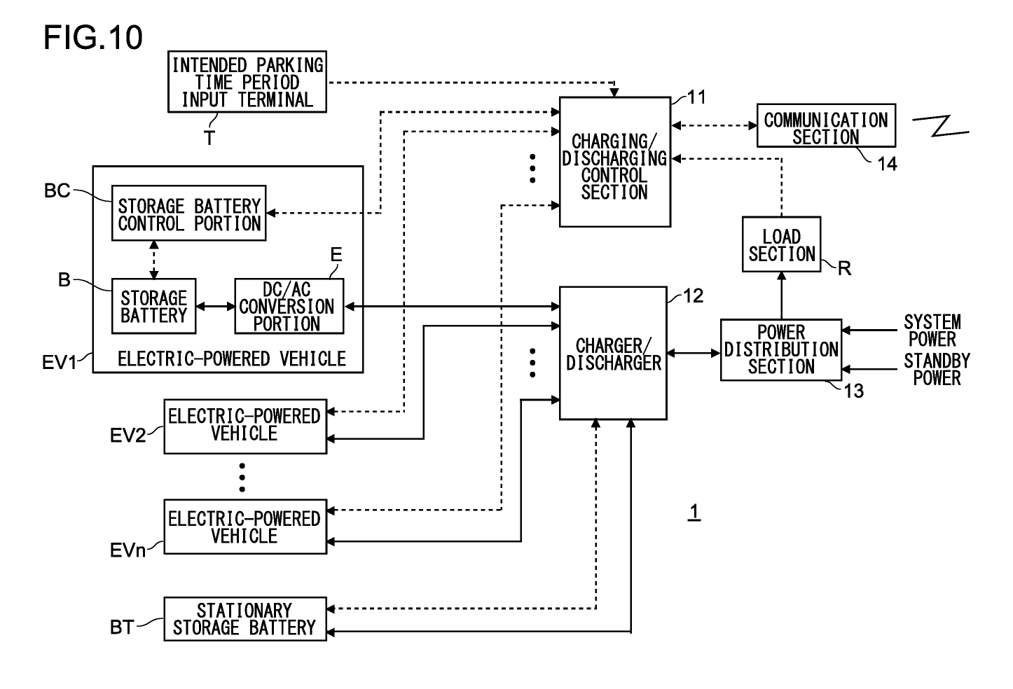

FIG. 10 shows a system configuration. Although a configuration similar to that shown in FIG. 1 also may be adopted, this working example uses a system in which a load amount to be subjected to peak shaving with respect to a full-load capacity is assumed to be 100 kWh based on previous performance and that further includes a stationary storage battery BT and a communication section 14.

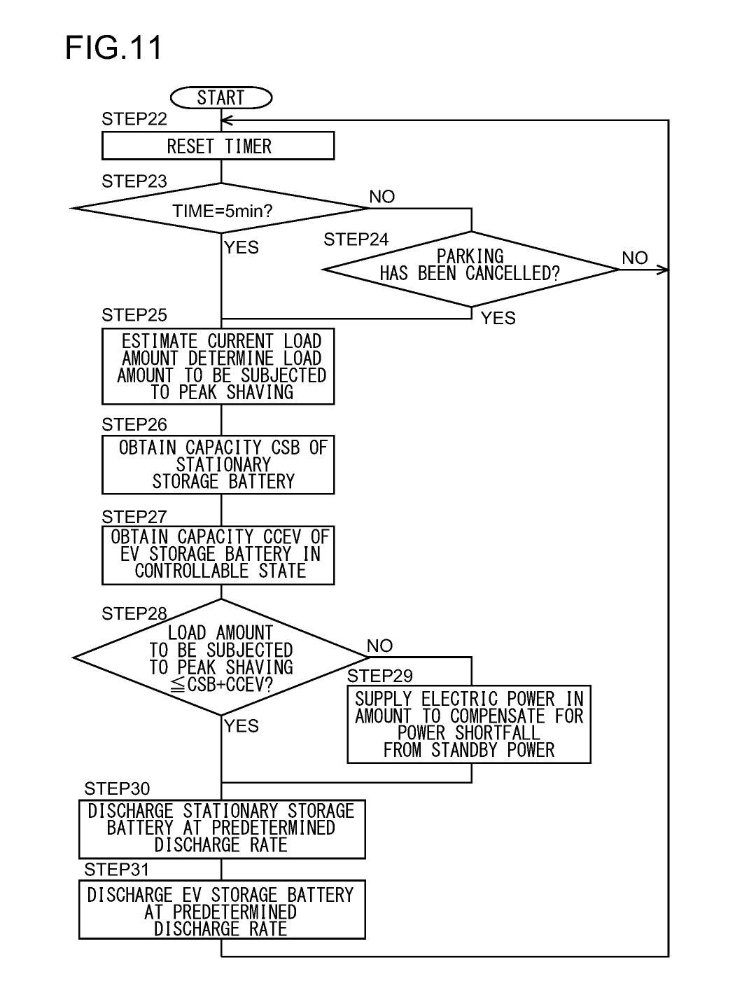

In a case where there occurs no shortage in capacity of the storage battery B of the electric-powered vehicle EVn, which is in the controllable state, that is, in a case where the electric-powered vehicle EVn is parked for a duration of the “intended parking time period” set by the user who parked it, it is sufficient to have electric power in an amount of 100 kWh in total where the capacity of the stationary storage battery is set to 80 kWh and the amount of electric power of the EV storage battery is set to 20 kWh. In this working example, in order to deal with a situation where there occurs a shortage in capacity of the storage battery due to a change in the user's schedule, the EV storage battery is set to have threefold capacity redundancy, and thus while the capacity of the stationary storage battery is set to 80 kWh, the amount of electric power of the EV storage battery is set to 60 kWh. Discharging for peak shaving is performed in such a manner that the stationary storage battery is first discharged, and then the EV storage battery is discharged to compensate for a power shortfall. In this case, from the viewpoints of achieving a longer service life of the stationary storage battery and of maintaining a given capacity of the EV storage battery, the stationary storage battery is discharged at a discharge rate of 80% (64 kWh), and the EV storage battery is discharged at a discharge rate of 60% (36 kWh). FIG. 11 shows a flow of power supply control performed using this system. In this flow, when triggered by the user changing or cancelling the intended parking time period, recalculation of a load amount is performed, and based on a result of the recalculation, electric power in an amount to compensate for a power shortfall is supplied from the EV storage battery having capacity redundancy or acquired from any other form of standby power. Any other form of standby power is, for example, electric power jointly pooled by this store and any other store(s) or electric power purchased from a retailer of electric power.

Upon start of the control shown in FIG. 11, timer resetting is performed (STEP 22).

It is judged whether or not five minutes have elapsed since the timer resetting (STEP 23) or whether or not parking has been cancelled (STEP 24).

If it is judged that five minutes have elapsed or that parking has been cancelled, a current load amount is predicted, and based on a result of the prediction, a load amount that should be subjected to peak shaving is determined (STEP 25).

Next, capacity data CSB of the stationary storage battery is obtained (STEP 26), and a capacity CCEV of the EV storage battery in the controllable state is obtained (STEP 27).

Then, it is judged whether or not the load amount to be subjected to peak shaving determined at STEP 25 exceeds a total of a current value of the capacity CSB of the stationary storage battery and a current value of the capacity CCEV of the EV storage battery in the controllable state (STEP 28).

If it is judged that the load amount to be subjected to peak shaving exceeds the total, electric power in an amount to compensate for a power shortfall is supplied from standby power (STEP 29). The standby power described herein is electric power jointly pooled by this store and any other store(s) or electric power purchased from a retailer of electric power.

Furthermore, if, at STEP 28, it is judged that the load amount to be subjected to peak shaving does not exceed the total, at STEP 30, electric power is discharged from the stationary storage battery into loads. After that, electric power is discharged from the EV rechargeable battery into the loads (STEP 31).

After that, a return is made to Step 22, and the processes at STEP 22 to STEP 31 are repeatedly performed.

With the foregoing system and control, for example, in a case where the load amount to be subjected to peak shaving is assumed to be 100 kWh, while the maximum capacity of the stationary storage battery is set to 80 kWh, the EV storage battery in the controllable state is set to have 40 kWh of capacity redundancy, and the maximum capacity thereof, therefore, is set to 60 kWh. Moreover, based on a result of prediction of a current load amount, the load amount to be subjected to peak shaving is determined. In a case where the amounts of electric power of the stationary storage battery and the EV storage battery are not sufficient to perform peak shaving, a power shortfall is calculated in advance, and electric power in an amount to compensate for the power shortfall is supplied from a standby power source. This makes it possible to deal with a variation in capacity of the EV storage battery in the controllable state.

When a plurality of EV storage batteries are used for discharging, by performing switching between the plurality of EV storage batteries and any other power source(s) in an overlapping manner, the discharging can be performed smoothly without being interrupted.

Furthermore, the communication section 14 is connected to the charging/discharging control section 11 so that a command to cancel parking can be issued via the user's mobile phone or the like to the charging/discharging control section, and thus it is also possible to facilitate cancelling. Moreover, information on a charging/discharging state of the EV storage battery of the user's automobile can be provided to the user via a mobile phone, a terminal, or the like, and thus the user can grasp the charging/discharging state of his/her automobile, so that the user can be relieved of concerns and make effective use of his/her time.

While the foregoing has discussed the one embodiment according to the present invention, the scope of the present invention is not limited thereto, and the present invention can be implemented in variously modified forms without departing from the spirit of the invention.

### INDUSTRIAL APPLICABILITY

The present invention is applicable to a power supply system that supplies electric power through control of charging and discharging of a storage battery. The present invention is favorably applicable to a power supply system that controls charging and discharging of a storage battery provided in an electric-powered vehicle.

### LIST OF REFERENCE SYMBOLS

1 power supply system

11 charging/discharging control section

111 control-enabled time period estimation portion

112 database

113 load amount estimation portion

114 time period setting portion

115 timing determination portion

12 charger/discharger

13 power distribution section

14 communication section

100 power administrator

EVn electric-powered vehicle

B storage battery

BC storage battery control portion

E DC/AC conversion portion

T intended parking time period input terminal

R load section

P power company

1-12. (canceled)

13. A power control apparatus that supplies electric power to a load via a charger/discharger and controls a plurality of storage batteries into which electric power supplied via the charger/discharger is charged, the power control apparatus comprising:
a time period estimation portion that estimates a control-enabled time period of each of the plurality of storage batteries connected to the charger/discharger;
a determination portion that, based on the control-enabled time period, determines a timing for performing at least one of charging and discharging of each of the plurality of storage batteries; and
a setting portion that sets a recommended discharging time period in which each of the storage batteries should be discharged,
wherein
each of the plurality of storage batteries is provided in an electric-powered vehicle,
based on a time period for which the electric-powered vehicle is intended to be parked, the time period estimation portion estimates the control-enabled time period of each of the storage batteries,
the determination portion determines at least part of an overlapping time period between the control-enabled time period and the recommended discharging time period as a discharging timing of each of the storage batteries, and
the determination portion performs switching between respective charging timings of the plurality of storage batteries so that the respective charging timings are shifted from each other and switching between respective discharging timings thereof so that the respective discharging timings are shifted from each other.

14. The power control apparatus according to claim 13, wherein
the determination portion determines the respective charging timings of the plurality of storage batteries so that the respective charging timings do not overlap with each other and the respective discharging timings thereof so that the respective discharging timings do not overlap with each other.

15. The power control apparatus according to claim 1, wherein
the determination portion determines respective discharging timings of the plurality of storage batteries so that the respective discharging timings overlap with each other.

16. The power control apparatus according claim 13, wherein
the determination portion determines as the charging timing of each of the storage batteries, at least part of a period of time that falls within the control-enabled time period and outside the recommended discharging time period.

17. The power control apparatus according to claim 13, wherein
the determination portion determines the discharging timing and the charging timing so that an amount of electric power discharged from each of the storage batteries at the discharging timing substantially equals an amount of electric power charged into the each of the storage batteries at the charging timing.

18. The power control apparatus according to claim 13, wherein
in a case where there is no overlapping period of time between the control-enabled time period and the recommended discharging time period, the determination portion sets only the charging timing that falls within the control-enabled time period without setting the discharging timing that falls within the control-enabled time period.

19. The power control apparatus according to claim 13, wherein
in a case where a predetermined one of the storage batteries is disconnected from the charger/discharger after having been connected thereto for a time period shorter than a duration of the control-enabled time period of said predetermined one of the storage batteries, the determination portion determines a discharging timing of any other one of the storage batteries so that electric power in an amount to compensate for a power shortfall from an amount of electric power that was originally supposed to be supplied from the predetermined one of the storage batteries to the load is supplied from said any other one of the storage batteries to the load.

20. The power control apparatus according to claim 13, further comprising:
a load amount estimation portion that estimates an amount of electric power to be supplied to the load by the power control apparatus,
wherein the setting portion sets as the recommended discharging time period, a time period in which, by the load amount estimation portion, the amount of electric power to be supplied to the load by the power control apparatus is estimated to become larger than in other time periods.

21. The power control apparatus according to claim 13, wherein
the power control apparatus can use system power supplied from a power company, and
the setting portion sets as the recommended discharging time period, a time period in which a cost per unit amount of the system power is high and as a recommended charging time period, a time period in which the cost per unit amount of the system power is low.

22. The power control apparatus according to claim 20, further comprising a stationary storage battery,
wherein controllable capacities of the stationary storage battery and each of the storage batteries provided in the electric-powered vehicle are detected, and
in a case where the controllable capacities of the stationary storage battery and the each of the storage batteries provided in the electric-powered vehicle are larger than a capacity estimated by the load amount estimation portion, the stationary storage battery is discharged at a predetermined discharge rate, and then the each of the storage batteries provided in the electric-powered vehicle is discharged.

23. The power control apparatus according to claim 22, wherein
in a case where the controllable capacities of the stationary storage battery and each of the storage batteries provided in the electric-powered vehicle are smaller than the capacity estimated by the load amount estimation portion, electric power in an amount corresponding to a difference capacity between the controllable capacities of the stationary storage battery and each of the storage batteries provided in the electric-powered vehicle and the capacity estimated by the load amount estimation portion is supplied from standby power.

24. The power control apparatus according to claim 22, wherein
the load amount estimation portion estimates a load capacity based on previous charging/discharging data.

25. The power control apparatus according to claim 22, wherein
at every predetermined time interval, a comparison is made between the controllable capacities of the stationary storage battery and each of the storage batteries provided in the electric-powered vehicle and the capacity estimated by the load amount estimation portion, and based on a result of the comparison, charging/discharging is performed.

26. The power control apparatus according to claim 22, wherein
in a case where a change is made to data on intended parking of the electric-powered vehicle, a comparison is made between the controllable capacities of the stationary storage battery and each of the storage batteries provided in the electric-powered vehicle and the capacity estimated by the load amount estimation portion, and based on a result of the comparison, charging/discharging is performed.

27. The power control apparatus according to claim 22, wherein
based on timings determined by the timing determination portion, the charger/discharger performs charging or discharging of each of the storage batteries provided in the electric-powered vehicle or the stationary storage battery.
